(19) United States
(12) Patent Application Publication
(10) Pub. No.: US 2013/0337411 A1
(43) Pub. Date: Dec. 19, 2013

(54) Prefabricated Thermoplastic Partial Denture Clasp with Improved Performance Characteristics and Kit Thereof

(71) Applicants: Daniel Schwartz, Williamstown, NJ (US); Frank Ricciardi, Turnersville, NJ (US)

(72) Inventors: Daniel Schwartz, Williamstown, NJ (US); Frank Ricciardi, Turnersville, NJ (US)

(21) Appl. No.: 13/848,751

(22) Filed: Mar. 22, 2013

Related U.S. Application Data
(60) Provisional application No. 61/614,620, filed on Mar. 23, 2012.

(51) Int. Cl. A61C 13/00; A61C 13/267

(52) U.S. Cl. CPC A61C 13/0003; A61C 13/267
USPC 433/178

(57) ABSTRACT

A pre-form for making a removable partial dental prosthesis. The pre-form has a tree-shape form having a central body portion and at least one arm extending laterally therefrom and a tail and a head positioned on opposite ends of the arm such that the arm is detachably affixed to the central body portion at the tail. The arm is incorporated into a molding for a removable partial dental prosthesis having a base, an artificial tooth supported by the base and a substantially transparent clasp. The clasp and base are formed to mate with oral mucosa for support of the prosthesis thereon. Also disclosed is a kit for making and inserting a partial dental prosthesis in a gap between natural teeth in a human mouth.

### CROSS-REFERENCE TO RELATED APPLICATIONS

The present patent application is based on Provisional Application Ser. No. 61/614,620 filed Mar. 23, 2012 the entirety of which is hereby incorporated by reference.

### FIELD OF THE INVENTION

The present invention pertains to fabricating removable partial dentures. More specifically, this disclosure is directed to prefabricated thermoplastic clasps for formed from lightweight and durable materials having improved performance characteristics for final and permanent formation of removable partial bridges.

### BACKGROUND OF THE INVENTION

Dentures are removable replacements for missing teeth and surrounding tissues. Generally speaking, there are two types of dentures that are available—complete dentures and partial dentures. Complete dentures are used when virtually all the teeth are missing, while partial dentures are used when some natural teeth remain. Typically, a removable partial denture or bridge usually consists of replacement teeth attached to a pink or gum-colored plastic base, which is usually connected by a metal framework that holds the denture in place in the mouth. Partial dentures are used when one or more natural teeth remain in the upper or lower jaw. A fixed (permanent) bridge replaces one or more teeth by placing crowns on the teeth on either side of the space and attaching artificial teeth to them. This “bridge” is then cemented into place. Not only does a partial denture fill in the spaces created by missing teeth, it prevents other teeth from changing position.

A removable partial denture (RPD) is for a partially edentulous dental patient who desires to have replacement teeth for functional or aesthetic reasons, and who cannot have a bridge (a fixed partial denture) for any number of reasons, such as a lack of required teeth to serve as support for a bridge (i.e. distal abutments) or due to financial limitations. The reason why this type of dental prosthesis is referred to as a removable partial denture is because patients can remove and reinsert them when required without professional help. Conversely, a “fixed” prosthesis can and should be removed only by a dental professional.

Processes for making partial dentures and/or repairing them are well known in the prior art. While attempts at fabricating less expensive and less cumbersome have been made, there still exists a need for simpler fabrication steps which save money and time for patients who may require emergency repairs. There also exists the need to avoid or at least minimize the intricate fabrication processes for the technician who would ordinarily have to use cumbersome lost wax processes for metal or injection molding for plastics.

One advantage of the present disclosure is a durable prefabricated thermoplastic clasp which embraces the tooth in lieu of metal. Prefabricated soft plastic forms in the shape of clasps have been made before to be used as dies in the burnout procedure and then case in steel. These metal and plastic forms were not the final product. Additionally, the plastic forms proved to be brittle and less durable than previously thought.

The present invention not only becomes the final product with the necessary shaping and bending, it provides a level of durability heretofore unknown. Not only does it provide for all the variations of teeth in the human mouth but it provides a template for quick use and storage not presently known. Additionally, the costs of materials and expenses typically associated with the fabrication of partial retainers are greatly reduced.

### DESCRIPTION OF THE PRIOR ART

Previously, standard procedure used involved, cumbersome, and time and money consuming processes. Whether the clasp fitting to the teeth was metal or plastic, the technician typically had to utilize the lost wax procedure or the injection molding process. In most cases, the clasps used were not the final product.

Previous patents include Napolitano, Orthodontic Method and Apparatus, U.S. Pat. No. 4,850,865 where wires were mounted on teeth, and

Dziki, Extra-Oral Dental Restoration, U.S. Pat. No. 4,854,875, where a molten thermoplastic resin was used in restorative dentistry, and

Garay, Tooth-anchored Beneficial Agent Delivery Device, U.S. Pat. No. 4,861,268, where a delivery device was adapted to be semi-permanently affixed to an anchoring tooth, and

Holsclaw, Dental Bridge and Method, U.S. Pat. No. 4,877,400, where a dental bridge is constructed between abutment teeth, and

Alleluia, Method of Making a Dental Prosthesis, U.S. Pat. No. 4,562,882 where a dental prosthesis is made from a metallic base, and

Kipp, Support for a Removeable Dental Prosthesis, U.S. Pat. No. 4,380,436 where a removable prosthesis is made, and Rieger, Dental Prosthesis, U.S. Pat. No. 4,846,718 where a lightweight dental prosthesis is made of a thimble shaped metallic substance, and

Harvey, Permanent Dental Prosthesis, U.S. Pat. No. Re. 32,972 where a permanent secured prosthesis is made, and

Bryan, Method for Thermoset-Thermoplastic Molded Article, U.S. Pat. No. 4,850,871 where a thermoplastic mold is made, and

Breads, Method of Making a Dental Appliance, U.S. Pat. No. 4,798,534 where a method of making a dental appliance is outlined, and

Salvo, Dental Bridge, U.S. Pat. No. 4,820,157 where a dental bridge is made, and

Tatemoto, Denture Base, U.S. Pat. No. 4,826,435 where a dental base of a thermoplastic flouroelastomer is made, and

Shoher, Prefabricated Dental Prosthesis, U.S. Pat. No. 4,826,436 where a prefabricated Dental Prosthesis is made without casting, and

Tanaka, Material Packs for Preparing Plate Dentures, U.S. Pat. No. 4,838,789 where a photopolymerizable resin is made, and

Soroca, Prefabricated Thermoplastic Clasp, U.S. Pat. No. 5,102,337 where a prefabricated thermoplastic clasp which embraces the tooth in lieu of metal is used and

Lichkus, et al., U.S. Pat. No. 6,855,278 where a method of making a removable partial dental prosthesis having a base, an artificial tooth supported by the base and a clasp is formed to mate with oral mucosa for support of the prosthesis.

### SUMMARY OF THE INVENTION

This invention pertains to an orthodontic pre-form for a thermoplastic clasp for fitting, holding and anchoring a partial prosthesis comprising at least one crystalline polymeric material. The present invention relates to a partial prosthesis which is affixed to adjacent natural teeth, may be articulated precisely to the natural teeth, provides no interference with the natural teeth and is simple in construction, operation and insertion so that virtually no discomfort is created during the process.

The invention further relates to a kit containing the basic materials needed to make and install the partial prosthesis. The kit includes detailed, fully illustrated instructions for carrying out the procedure described herein, as well as the elements necessary to perform the process.

The use of crystalline polymers in forming the orthodontic pre-forms results in clasps exhibiting increased strength and durability. In an embodiment, the orthodontic pre-forms have a linear stick-like structure that can be easily shaped and bent and which can be readily adapted for a variety of differently sized teeth. These may also be arranged in a tree-like structure which facilitates handling, storage and inventory control. In other embodiments, the pre-form may include an arcuate member at one end which is pre-adapted for positioning around the base of a tooth. The pre-form becomes the final product or clasp when contoured by a technician who applies heat to the area which is to be bent and shaped to form the clasp for a partial denture. An electric heat apparatus with a small orifice and spatula tip allows precise concentration of heat to the area to be bent and shaped. The clasps made from the pre-form can be fabricated in clear or tooth color shades and can be added to existing as well as new partials. Amorphous polymeric materials may also be added to provide enhanced elasticity, flexibility, and toughness.

Thermoplastics, also known as thermosoftening plastics are polymers that turn to a liquid when heated and freeze (or set) to a very glassy state when cooled sufficiently. Most thermoplastics are high-molecular-weight polymers whose chains associate through weak Van der Waals forces (polyethylene); stronger dipole-dipole interactions and hydrogen bonding (nylon); or even stacking of aromatic rings (polystyrene).

Thermoplastic polymers differ from thermosetting polymers (e.g. phenolics, epoxies) in that they can be remelted and remolded. Many thermoplastic materials are addition polymers; e.g., vinyl chain-growth polymers such as polyethylene and polypropylene; others are productions of condensation or other forms of polyaddition polymerization, such as the polyamides or polyester.

One example of a class of suitable crystalline polymers for use in forming orthodontic pre-forms are polyaryletherketones, a specific example of which is PEEK, manufactured by Victrex USA, Inc., located in Greenville, S.C. The basic unit of the polyaryletherketone sold under the trade name PEEK is as follows:

PEEK 151G is a specific grade of PEEK crystalline polymer that is especially useful in forming orthodontic pre-forms according to the disclosure. PEEK is a thermoplastic polyaryletherketone polymer that is capable of forming a crystalline structure that offers an outstanding combination of physical properties including excellent wear resistance, strength and stiffness.

Crystalline nylons (a type of polyamide) are another class of suitable crystalline polymers for use in forming orthodontic pre-forms. A specific example of a crystalline nylon is TROGAMID, manufactured by Degussa AG, located in Germany. The basic unit of one type of TROGAMID nylon sold under the trade name TROGAMID CX is as follows:

TROGAMID CX grade is a specific grade of TROGAMID that is especially useful in forming orthodontic pre-forms according to the disclosure. TROGAMID CX is a thermoplastic polyamide polymer that is capable of forming a crystalline structure that offers an outstanding combination of physical properties including excellent wear resistance, strength and stiffness, and transparency. The microcrystalline structure has the advantage that the positive properties arising from crystallinity, such as stress-cracking resistance, are retained without clouding of the material. The crystalline proportion is so low, however, that it does not negatively impact the shrinkage behavior of the molded part; the isotropic shrinkage behavior observed in amorphous materials is retained in TROGAMID CX.

According to one embodiment, in addition to at least one type of crystalline polymer, the orthodontic pre-form may further include an amorphous polymer. Examples of suitable amorphous polymeric materials include polyetherimides, a specific example of which is ULTEM, manufactured by General Electric. ULTEM 1000 and ULTEM 1010 are specific grades of ULTEM that have been found to be useful. ULTEM polymers are amorphous and offer enhanced elasticity, flexibility, and toughness at room temperature. Other suitable materials that could be used as an optional amorphous component include polycarbonate resins, amorphous polyaryletherketone resins, acetal polymer resins, or other amorphous polymer resins known in the art.

In an embodiment, one form of the pre-form consists of a tree-like structure having a plurality of “branches” extending outwardly in generally planar fashion in opposite directions from a central “trunk” or core. Each is branch is between 2 to 2¼ inches long, tapering in thickness from base to tail from 0.08 inches to 0.06 inches. A typical pre-form may have between 6 to 20 branches or arms. In another embodiment, the distal end of the branch may include a curved end which is tapered to between 0.020 to 0.025 inches diameter to allow for more precise fabrication and formation of the clasp. It will be appreciated that the pre-form may include a number of branches or arms having different thicknesses and/or tapers. Likewise, it will be understood that the number of branches or arms on the pre-form does not matter except to make available to the technician the right size clasp for the tooth to which it is to be attached.

In an alternate embodiment, the pre-form can comprise a linear, tube-like extrusion which may be spooled or otherwise dispensed from a single length of thermoplastic materials. In such embodiments, it will be appreciated that the pre-form may be in a more flexible state prior to heat setting than that which may exist in the tree-like structure form. The degree of flexibility in the linear pre-form can be controlled and is a function of the formulation of the thermoplastic materials and additives.

In still other embodiments of the invention of the preset disclosure, the pre-form may be part of a kit containing the basic materials needed to make and install the dental prosthesis of the present invention. The kit includes detailed, fully illustrated instructions for carrying out the procedure described herein, as well as the elements necessary to perform the process including, for example, a sufficient number of pre-forms, a suitable heat source, three prong pliers or other similar clasp forming tools, forming and polishing wheels, glues and glue accelerators, and acrylic resins as may be required.

It is an advantage of this disclosure to provide a substantially clear clasp for use with new or old partials which when shaped and fitted becomes the final product without requiring other processes and substances.

Another advantage of this disclosure is to provide a ready-made prefabricated thermoplastic pre-form for fabricating clasps which embraces the teeth to which it is anchored while holding the partial to which it is fitted without the need for unsightly, more expensive and less easily fabricated metal clasps.

Yet another advantage of the present invention is to provide a pre-form useful for fabricating tooth bearing partial dentures as well as provide a pre-form which may be readily used to replace or repair metal clasps.

Another advantage of the instant disclosure is to provide a clasp that can be formed for anterior, pre-molar or molar teeth which can be adjusted easily by a dental professional chair-side, if needed.

Yet another advantage of the disclosure is to provide a moldable pre-form that this semi-rigid yet has 100% shape memory.

Still another advantage of this disclosure is to provide a quick, aesthetic and efficient way to construct partials using a prefabricated clear or tooth shaded thermoplastic clasp requiring only shaping and heating to fit and become the final product.

In a best mode the pre-form is injection molded. A laboratory technician then contours a branch of the pre-form to fabricate the clasp or clasps to the anchoring teeth with whatever type clasps are needed, and affixes them to the partial. In this manner, for additions or repairs re-fitting becomes unnecessary. For new cases a fitting or trying on may be required. The clasps are the final finished product made from the pre-form.

### BRIEF DESCRIPTION OF THE DRAWINGS

FIG. 1 is a side front view of a pre-form of the present disclosure ready for multiple uses with partial prosthesis.

FIG. 2 is a side perspective view of the pre-form shown in FIG. 1

FIG. 3 is a side front view of an alternative embodiment of a pre-form of the present disclosure.

FIG. 4 is a side perspective view of the pre-form shown in FIG. 3.

FIG. 5 is a side view of a clasp of FIG. 3 shaped around the crown of a tooth showing the tail portion is positioned to hold the partial prosthesis to the clasped tooth.

FIG. 6 is a side front view of an alternate pre-form of the present disclosure.

FIG. 7 is a side front view of another alternate pre-form of the present disclosure.

FIG. 8 is a side view of a linear embodiment of the pre-form of the present disclosure shown on a spool.

FIG. 9 is a top plan view of one embodiment of a kit containing the pre-form of the present invention and accessories.

### DETAILED DESCRIPTION OF THE DRAWINGS

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

In the description of embodiments of the invention disclosed herein, any reference to direction or orientation is merely intended for convenience of description and is not intended in any way to limit the scope of the present invention. Moreover, the features and benefits of the invention are illustrated by reference to exemplified embodiments. Accordingly, the invention expressly should not be limited to such exemplified embodiments illustrating some possible but non-limiting combination of features that may be provided alone or in other combinations of features; the scope of the invention being defined by the claims appended hereto.

While the invention will be described in terms of the preferred embodiments it will be understood that it is not intended to limit the invention to these embodiments. On the contrary, it is intended to cover all alternative, modifications and equivalents as may be included within the spirit and scope of the invention as defined by the appended claims.

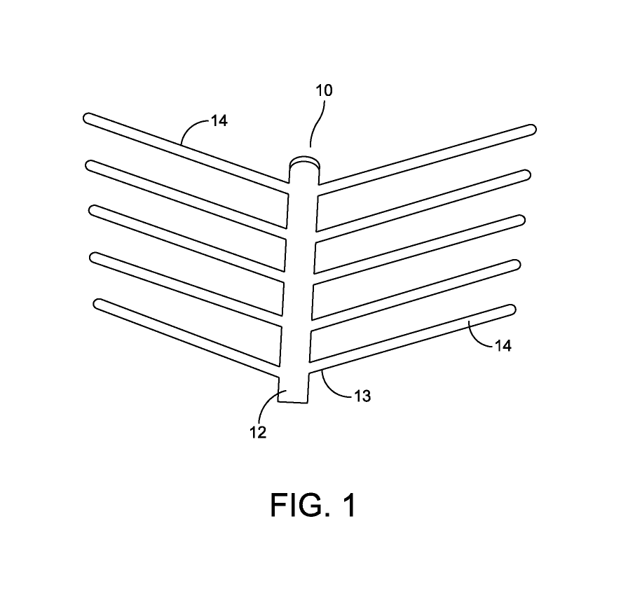

FIG. 1 is a side view of the pre-form 10 of the present invention having a “tree-shape” with central trunk or body 12 having a plurality of branches or arms 14 positioned on either side of a central body 12 extending outwardly and in opposite directions in a planar fashion. Arm 14 has a head portion 16 distal from central body 12 and tail portion 13 located proximally to central body 12. In the embodiment shown, the pre-form is generally planar in that the arms 14 extend more or less on the same plane. This is simply manufacturing and fabrication preference in the formation of the pre-form and it will be appreciated that arms 14 may be greater or fewer in number and or may also extend in other than planes generally defined by an x-y axis. The pre-form consists of a prefabricated thermoplastic device which can be trimmed accordingly to the size of the tooth being clasped. When this determination is made, the length of arm 14 is simply trimmed and the clasp may be formed therefrom. Each of these clasps wrap around the crown of the anchoring tooth via head 16 and tail portion 13 which is positioned to engage the partial prosthesis ensuring a snug fit.

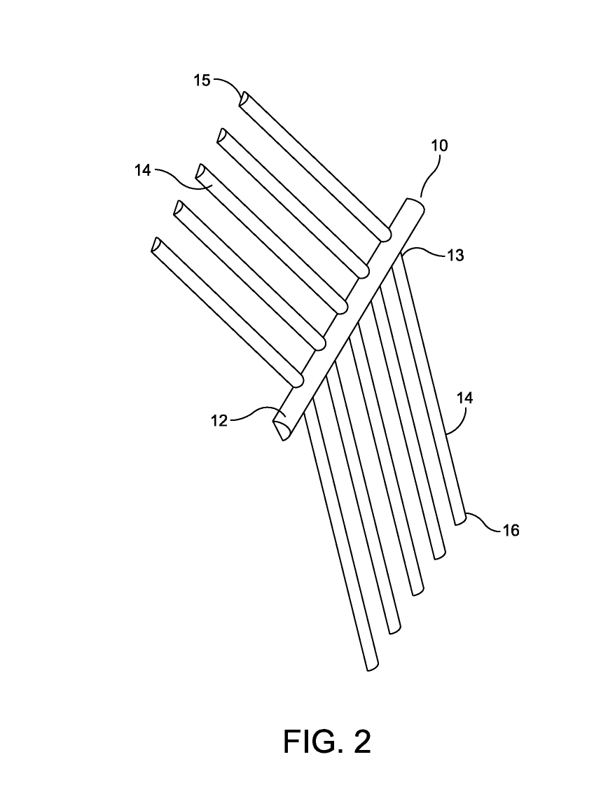

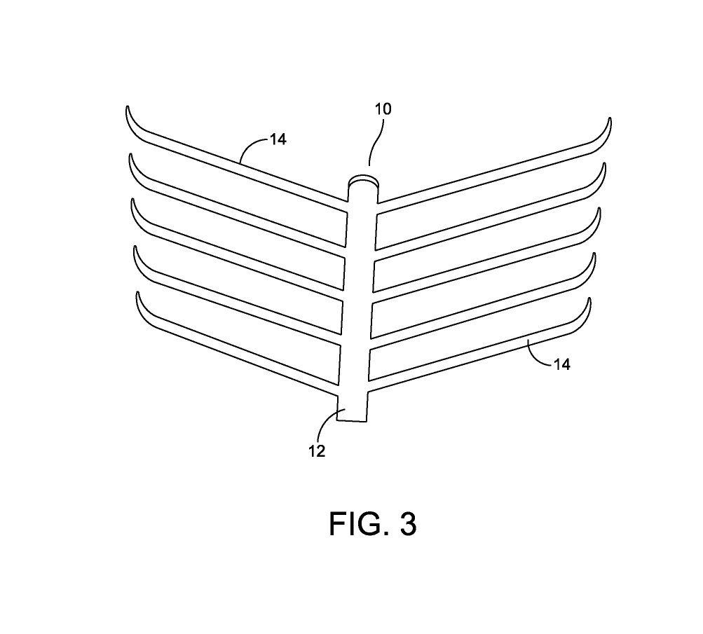

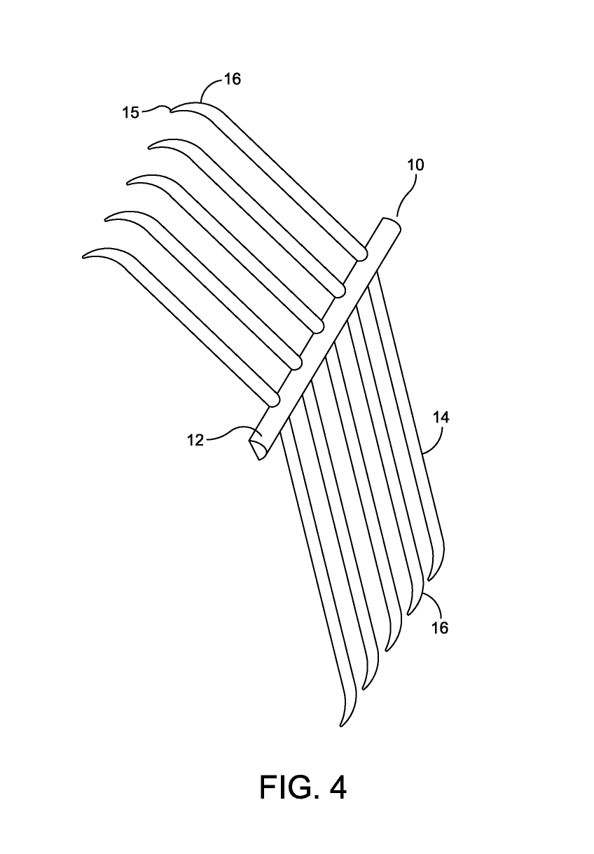

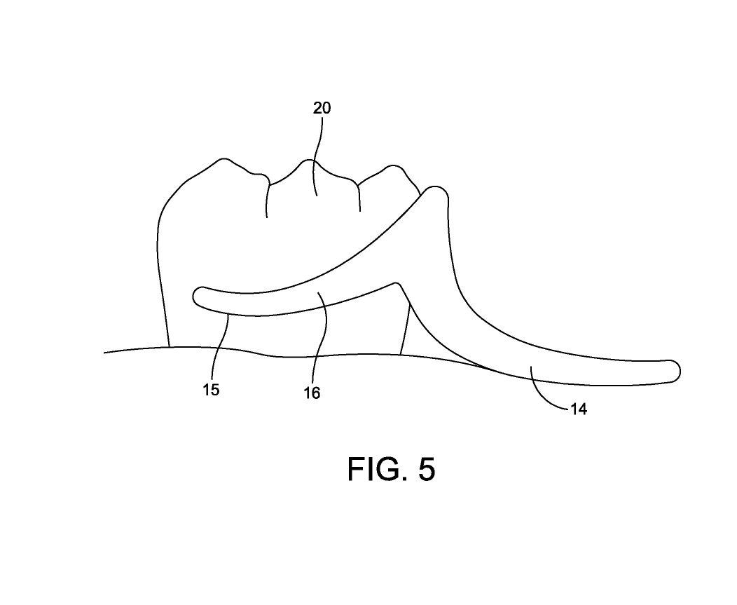

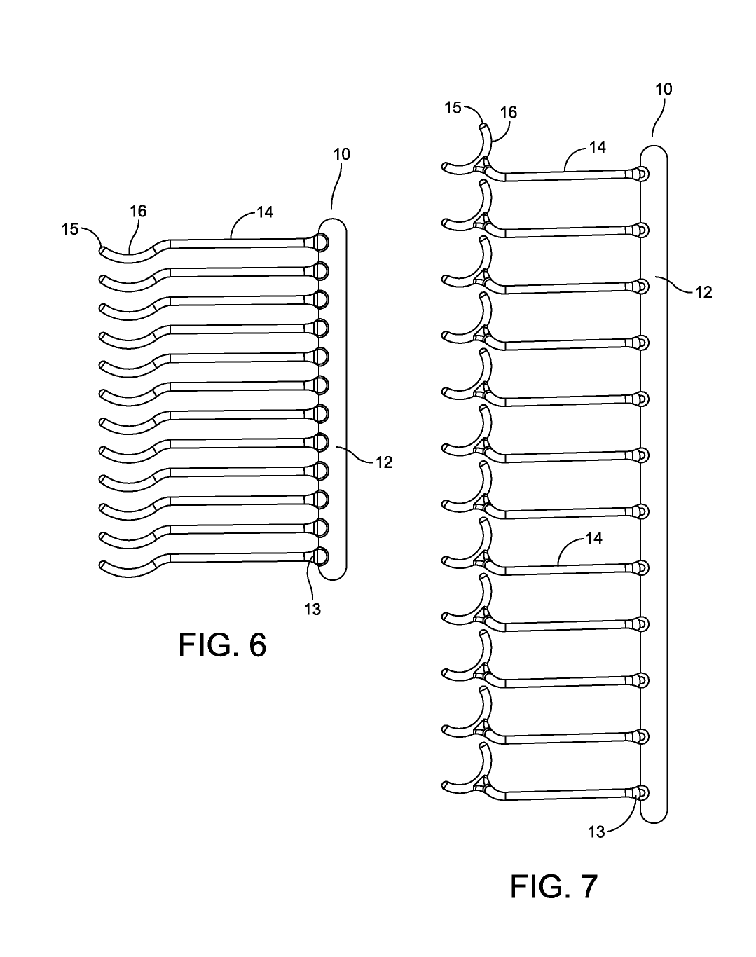

FIG. 2 is a side perspective view of the pre-form 10 shown in FIG. 1. Central body 12 is shown having a plurality of arms 14 extending outwardly and in opposite directions positioned on either side of centrally positioned body 12. Arm 14 has a head portion 16 distal from central body 12 and tail portion 13 located proximally to central body 12. In the embodiment shown, it will be further appreciated that the pre-form is generally planar with a flattened lower or bottom surface. The arms 14 extend more or less on the same plane with the lower portion of the plane being defined by a substantially flat planar bottom surface. Shown more clearly with respect to tip 15, the flat bottom surface defines the lower surface of pre-form 10. In this embodiment, tip 15 is shown having a slightly half-moon shape, with the upper surface forming the arcuate portion with the bottom portion being substantially flat. It will be understood that with respect to FIG. 2, FIG. 3, FIG. 4, FIG. 5, FIG. 6 and FIG. 7, the arc or hook portion 15 of head 16 may be of different sizes with some being larger or smaller than others and that these varying sizes in many instances are useful to quickly adapt the pre-form to abutment teeth of different sizes. The configuration of the bottom surface is a manufacturing and fabrication preference in the formation of the pre-form and it will be appreciated that the bottom surface may be rounded, beveled, elliptical or take other shapes. Additionally, it will be appreciated that the upper surface of the pre-form need not be rounded or arcuate and may also be generally flat and/or planar.

FIG. 3 is a side view of an alternate pre-form 10 of the present invention having a “tree-shape” with central trunk or central body 12 having a plurality of branches or arms 14 positioned on either side of central body 12 extending outwardly and in opposite directions. Arm 14 has a head 16 distal from central body 12 and tail 13 located proximally to central body 12. In the embodiment shown, head 16 is shown having a generally “arc or hook-shaped” tip 15 for assistance in securing a clasp made from the pre-form to a tooth. As is the case in FIGS. 1 and 2, pre-form 10 is generally planar in that the arms 14 extend outwardly more or less on the same plane. It will likewise be appreciated that arms 14 may be greater or fewer in number and or may also extend in other than planes generally defined by an x-y axis. The pre-form consists of a prefabricated thermoplastic device which can be trimmed accordingly to the size of the tooth being clasped. When this determination is made, the length of arm 14 is simply trimmed and the clasp may be formed therefrom. Each of these clasps wrap around the crown of the anchoring tooth via head 16 and tail portion 13 which is positioned to engage the partial prosthesis ensuring a snug fit

FIG. 4 is a side perspective view of the pre-form 10 shown in FIG. 3. Central body 12 is shown having a plurality of arms 14 extending outwardly and in opposite directions positioned on either side of centrally positioned body 12. Arm 14 has a head portion 16 distal from central body 12 and tail portion 13 located proximally to central body 12. Head 16 is shown having a generally “arc or hook-shaped” tip 15 for assistance in securing a clasp made from the pre-form to a tooth. The arms 14 extend more or less on the same plane with the lower portion of the plane being defined by a substantially flat planar bottom surface. In the embodiment shown, it will be further appreciated that the pre-form is generally planar with a flattened lower or bottom surface. Shown more clearly with respect to tip 15, the flat bottom surface defines the lower surface of pre-form 10. In this embodiment, tip 15 is arc or hook-shaped and has a slightly half-moon shape, with the upper surface forming the arcuate portion with the bottom portion being substantially flat. The configuration of the bottom surface is a manufacturing and fabrication preference in the formation of the pre-form and it will be appreciated that the bottom surface may be rounded, beveled, elliptical or take other shapes. Additionally, it will be appreciated that the upper surface of the pre-form need not be rounded or arcuate and may also be generally flat and/or planar.

FIG. 5 shows a larger molar with crown, 20, being engaged by the tip 15, of head 16 while its body 14 is positioned to hold the partial prosthesis.

FIG. 6 is a side view of another alternate pre-form 10 of the present invention with central body 12 having a plurality of branches or arms 14 positioned on one side of central body 12 extending outwardly. Arm 14 has a head 16 distal from central body 12 and tail 13 located proximally to central body 12. In the embodiment shown, head 16 is shown having a generally “arc or hook-shaped” tip 15 for assistance in securing a clasp made from the pre-form to a tooth. Pre-form 10 is generally planar in that the arms 14 extend outwardly more or less on the same plane. It will be appreciated that arms 14 may be greater or fewer in number and or may also extend in other than planes generally defined by an x-y axis. The pre-form consists of a prefabricated thermoplastic device which can be trimmed accordingly to the size of the tooth being clasped. When this determination is made, the length of arm 14 is simply trimmed and the clasp may be formed therefrom. Each of these clasps wrap around the crown of the anchoring tooth via head 16 and tail portion 13 which is positioned to engage the partial prosthesis ensuring a snug fit.

FIG. 7 is a side view of another alternate pre-form 10 of the present invention with central body 12 having a plurality of branches or arms 14 positioned on one side of central body 12 extending outwardly. Arm 14 has a head 16 distal from central body 12 and tail 13 located proximally to central body 12. In the embodiment shown, head 16 is shown having a generally “cresent-shaped” tip 15 for assistance in securing a clasp made from the pre-form to a tooth. Pre-form 10 is generally planar in that the arms 14 extend outwardly more or less on the same plane. It will be appreciated that arms 14 may be greater or fewer in number and or may also extend in other than planes generally defined by an x-y axis. The pre-form consists of a prefabricated thermoplastic device which can be trimmed accordingly to the size of the tooth being clasped. When this determination is made, the length of arm 14 is simply trimmed and the clasp may be formed therefrom. Each of these clasps wrap around the crown of the anchoring tooth via head 16 and tail portion 13 which is positioned to engage the partial prosthesis ensuring a snug fit. Additionally, it will be appreciated that the upper surface of the pre-form need not be rounded or arcuate and may also be generally flat and/or planar.

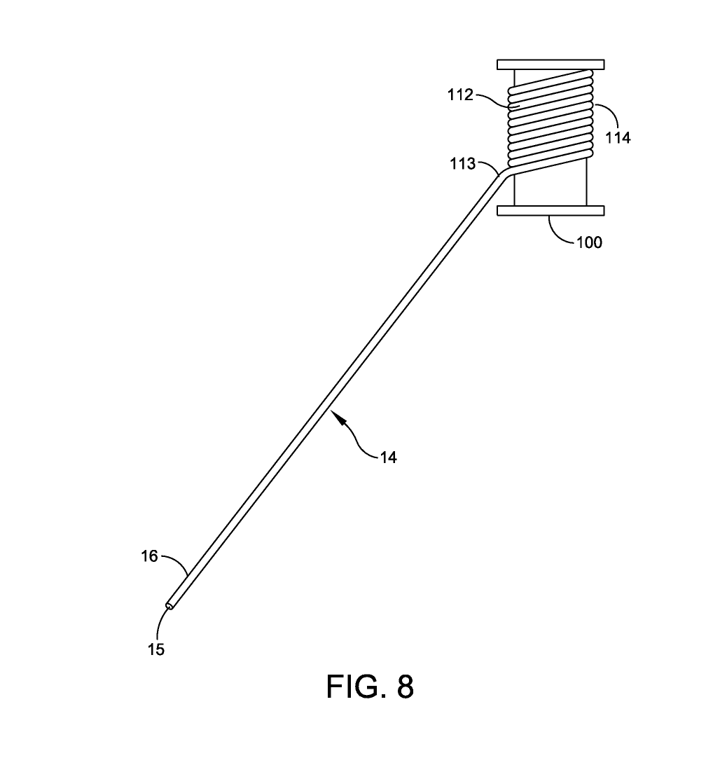

FIG. 8 is a side view of a linear embodiment of the pre-form 10 of the present disclosure shown on spool 114. In this embodiment, central body 112 is shown as a coil of the thermoplastic material with a single arm 14 extending outwardly from spool 114. Arm 14 has a head 16 distal from central body 112 and tail 113 located proximally to central body 112. It will be appreciated that in this embodiment, arm 14 can be trimmed to length as desired and that head 16 and tip 15 can be shaped more or less in-situ during the fabrication process. In this regard, it will be appreciated that the spool will be the at least one pre-form having central core and having at least one arm extending laterally from said central body portion. In such embodiments, this would allow for a greater variety of customizable fittings than would embodiments have fixed arm lengths. In this alternate embodiment, the pre-form can comprise a linear, tube-like extrusion which may be spooled or otherwise dispensed from a single length of thermoplastic materials. It will be understood that the pre-form may be in a more flexible state prior to heat setting than that which may exist in the tree-like structure forms as shown in FIGS. 1-7. The degree of flexibility in the linear pre-form can be controlled and is a function of the formulation of the thermoplastic materials and additives.

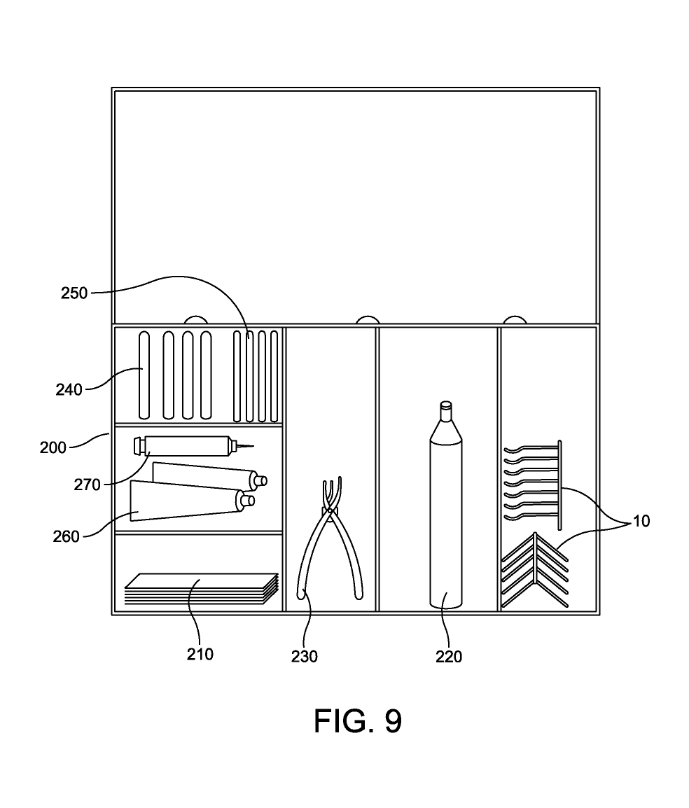

FIG. 9 is a top plan view of a kit form of the present invention. Kit 200 shows an example of some of the components, such as illustrated instructions 210 for carrying out the procedure described herein, as well as the elements necessary to perform the process including, for example, a sufficient number of pre-forms 10, a suitable heat source 220, three prong pliers 230 and/or other similar clasp forming tools, forming wheel 240, polishing wheel 250, glues and glue accelerators 260, and optional acrylic resins 270. Kit 200 typically comprises a generally rectangular container having a lidded, snap-fit closure and preferably having several compartments for storing and retaining the kit components.

In use, a dentist will first take an impression of the area where the partial is needed and from this impression the stone model is created. The technical work from the stone model which is a replica of the mouth generally proceeds as follows and take no part of the invention disclosed herein.

For example, when fabricating a replacement clasp, the metal clasp is cut off and the existing acrylic saddle an area is prepared by making room for the new plastic clasp; burr out enough of an area for the tail of the clasp to lie against proximal of abutment tooth, but not into an undercut; measure tooth from medial to center of distal proximal wall to determine which tail will be appropriate for size of clasp; trim accordingly; apply heat in a rotating motion and adapt clasp according to survey; tack with wax; spray with a separator like “Paint-N-Pour”® and hold in place with plaster leaving tail area exposed; cut undercuts into tail area; lute with quick cure acrylic and put in pressure pot (lukewarm water); remove plaster and define adaptation with heat gun and finish and polish.

When fabricating a new clasp, pre-form is first warmed sufficiently to make a tail end portion of the clasp malleable; the tail end is then adapted to fit around an abutment tooth of the mold and, if necessary, reformed with heated three prong pliers or other similar shaping tools; after the clasp is formed around the tooth, retention is created by bending a loop at the opposite end of the class to hold in acrylic; once retention is formed, the clasp is ready to be set in place on the frame; the classes secured on the frame by using glue and a glue accelerator; and finally, the acrylic is placed under the retentive area and above the clasp so that the clasp will remain in position.

The new type of prefabricated clasp formed from an improved thermoplastic pre-form which is the basis of this invention becomes the final product once shaped. The clasp is retentive device which engages an abutment tooth. An abutment tooth is the selected tooth to which the clasp is affixed. Basically, the thermoplastics replace conventional metal clasps. Metal clasps are either wrought wire, which is hand bent to shape, or cast as in the lost wax technique. The prefabricated thermoplastic clasp is pre-formed with retentive tails at different intervals depending on the size requirements and is the final product.

It will be appreciated that there can be various sizes with different retentive loops and shapes designed to fulfill the same premise. The prefabricated tails are made from thermoplastics that can be easily contoured and tacked to an already existing prosthesis or for starting a new one. The shape and size of the clasps as well as the tails can be different. A heating apparatus with a small orifice for an opening is required to heat and shape the clasp around the stone tooth. When the clasps have been satisfactorily contoured, they are tacked with a quick cure methyl methacrylate and added to the partial. Clasps are then refined, finished and polished and sent back to the dentist.

What is claimed is:

1. A pre-form for making a removable partial dental prosthesis, said pre-form having a tree-shape form comprising a central body portion and at least one arm extending laterally from said central body portion; said arm comprising a tail and a head positioned on opposite ends of said arm, wherein said arm is detachably affixed to said central body portion at said tail, said arm being incorporated into a molding for a removable partial dental prosthesis said prosthesis having a base, an artificial tooth supported by said base and a substantially transparent clasp, wherein said clasp is and said base are formed to mate with oral mucosa for support of said prosthesis thereon.

2. The pre-form of claim 1 wherein said arm further comprises a hook positioned at or near said head for securing said clasp to an anchor.

3. The pre-form of claim 2 wherein said anchor is selected from the group comprising teeth, posts and removable partial dentures.

4. A pre-form for making a removable partial dental prosthesis, said pre-form having central core and at least one arm extending laterally from said central body portion; said arm comprising a head portion positioned on said arm, wherein said arm is detachably affixed to said central core and said tail being formed by trimming said arm to a desired length, said arm being incorporated into a molding for a removable partial dental prosthesis said prosthesis having a base, an artificial tooth supported by said base and a substantially transparent clasp, wherein said clasp is and said base are formed to mate with oral mucosa for support of said prosthesis thereon.

5. A kit for making and inserting a partial dental prosthesis in a gap between natural teeth in a human mouth, said kit comprising:
at least one pre-form having central core and at least one arm extending laterally from said central body portion;
heat source selected from heat guns and bunsen-type burners for heating said pre-form at least one said arm;
pliers and/or other similar clasp forming tools for shaping and forming said at least one arm;
forming wheel;
polishing wheel; and
at least one adhesive material for securing said at least one arm to a support base for supporting an artificial tooth,
wherein said arm is detachably affixed to said central core and is trimmed to a desired length, said arm being incorporated into a support base comprising a molding for a removable partial dental prosthesis, an artificial tooth supported by and secured to said base and a substantially transparent clasp formed from said arm, wherein said clasp is and said base are formed to mate with oral mucosa for support of said prosthesis thereon.

6. The kit of claim 5 wherein said pre-form further comprises a plurality of said arms extending laterally and in opposite directions in a generally planar fashion from said central body portion.

7. The kit of claim 5, wherein said at least one arm further comprises at least one generally arc-shaped portion.

8. The kit of claim 7 comprising a plurality of arms and a plurality of such generally arc-shaped portions, including arc-shaped portions of at least two different sizes.

9. The kit of claim 7 comprising a plurality of such generally arc-shaped portions, including at least one said portion having a shape defined by the teeth of a human jaw.

10. The kit of claim 7 comprising a plurality of such generally arc-shaped portions including at least one such piece having a shape defined by the teeth of a lower human jaw.

11. The kit of claim 7 comprising a plurality of such generally arc-shaped portions including at least one such piece having a shape defined by the teeth of an upper human jaw.

12. The kit of claim 5, further comprising means for forming a bond between a support base and a length of said generally arch-shaped piece for permanently mounting the artificial tooth thereon.

13. The kit of claim 12, wherein said means for forming a bond comprises an adhesive material and further includes an accelerator for said adhesive material.

14. The kit of claim 5, further comprising a set of instructions explaining in detail the procedure to be followed in making and inserting said partial dental prosthesis.

15. The kit of claim 5, further comprising means for modifying the shape of a length of said arm to make it conform exactly to the mouth of a particular patient.

16. The kit of claim 5, wherein said at least one pre-form having central core and at least one arm extending laterally from said central body portion comprise clear thermoplastic materials.
